(19) United States
(12) Patent Application Publication
(10) Pub. No.: US 2007/0059674 A1
(43) Pub. Date: Mar. 15, 2007

(54) Computer-readable recording medium having stored recommended exhibition booth selection program and recommended exhibition booth selection method

(75) Inventors: Kosei Takano, Ota (JP); Kazuaki Honda, Ota (JP); Satomi Hitosugi, Ota (JP); Norio Takeda, Ota (JP); Yoko Mase, Ota (JP); Koji Uehara, Ota (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/283,744

(22) Filed: Nov. 22, 2005

(30) Foreign Application Priority Data
Aug. 12, 2005 (JP) 2005-233934

(51) Int. Cl. G09B 1/00

(52) U.S. Cl. 434/160

(57) ABSTRACT

A computer-readable recording medium having stored a recommended exhibition booth selection program that can determine the areas of interest of an individual user appropriately and can plan optimum booths to be visited at an exhibition. A learned-content-based interest judgment unit calculates a score indicating the degree of user's interest in each field, depending on what the user has learnt in the field. Then, an exhibition-booth-based interest judgment unit judges the field of content shown at each exhibition booth, sums up scores concerning the learning experience in the field, and calculates a score indicating the degree of user's interest in the exhibition booth. A recommended exhibition booth selection unit selects an exhibition booth having a high score with priority as a visit destination and creates a recommended exhibition booth list for the user.

### CROSS-REFERENCE TO RELATED APPLICATIONS

This application is based upon and claims the benefits of priority from the prior Japanese Patent Application No. 2005-233934, filed on Aug. 12, 2005, the entire contents of which are incorporated herein by reference.

### BACKGROUND OF THE INVENTION

1. Field of the Invention

The present invention relates to computer-readable recording media having stored a recommended exhibition booth selection program and recommended exhibition booth selection methods for guiding a visitor through exhibition booths, and particularly to a computer-readable recording medium having stored a recommended exhibition booth selection program and a recommended exhibition booth selection method for guiding the visitor through appropriate exhibition booths depending on the visitor's personal information.

2. Description of the Related Art

In the industrial community, individual corporations present exhibitions to show their products and services. In large exhibitions such as information technology shows, a great number of exhibitors present exhibition booths. Many visitors would have to see their business-related booths they are interested in efficiently in their busy schedules.

General visitors would select some booths they want to see before or after they arrive at the exhibition site, and go to the selected booths. Some exhibition brochures, however, do not provide sufficient information to make a judgment on what is shown at each exhibition booth. Some visitors overlook a booth that is closely related to their businesses and consequently miss the booth that should be seen.

A visitor who could reach a desired booth may not be able to obtain sufficient information to understand any completely new technology, product, or service during a short period of stop at the booth. Another visitor who happens to find a booth showing an interesting technology may want to obtain further information of the technology, but it is hard to find information sources and choose ones which are relevant. Therefore, it has been difficult to see exhibition booths efficiently.

One method addressing the problems described above estimates areas of interest of individual visitors from the records of booths they have stopped at and provides customized exhibition information to each visitor (Japanese Unexamined Patent Application Publication No. Hei-11-96230). The areas of interest of individual users are estimated just from the records of booths they have stopped at, but this estimation is less than adequate for judging areas of user's interest. A user may stop at a booth just to see what is shown and may find the booth not being interesting. This method, however, counts every stop at a booth, irrespective of whether the content of the exhibition booth matches an area of visitor's interest.

Accordingly, it is difficult to estimate from stop records that the visitor really needs the knowledge and information of a technology, product, or service shown at the booth.

### SUMMARY OF THE INVENTION

In view of the foregoing, it is an object of the present invention to provide a computer-readable recording medium having stored a recommended exhibition booth selection program and a recommended exhibition booth selection method that can judge areas of interest of an individual user appropriately and can recommend optimum visit destinations at an exhibition to the user.

To accomplish the above object, according to the present invention, there is provided a computer-readable recording medium having stored a recommended exhibition booth selection program for selecting a recommended exhibition booth in accordance with areas of interest of the user as a visit destination at an exhibition. The recommended exhibition booth selection program stored in the recording medium makes a computer function as: a learned-content-based interest judgment unit for calculating a score indicating the degree of user's interest in each field, depending on what the user has learnt in the field, with reference to a learning record storage unit storing learning records indicating what the user has learnt; an exhibition-booth-based interest judgment unit for determining, with reference to an exhibition information storage unit storing exhibition information describing a content shown at each booth of the exhibition, a field of content provided at the exhibition booth, summing up scores indicating learning records in the field, and calculating a score indicating the degree of user's interest in the exhibition booth; and a recommended exhibition booth selection unit for creating a list of exhibition booths recommended to the user by selecting an exhibition booth having a high score with priority as a visit destination.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows a general configuration of an embodiment of the present invention.

FIG. 2 shows a system configuration of the embodiment.

FIG. 3 shows a hardware configuration of a center server used in the embodiment.

FIG. 4 is a block diagram showing functions of the center server.

FIG. 5 shows information stored in an exhibition guidance information storage block.

FIG. 6 shows an example data structure of a first interest judgment table.

FIG. 7 shows an example data structure of a second interest judgment table.

FIG. 8 shows an example data structure of a scheduled stop period determination table.

FIG. 9 shows an example data structure of a booth-based interest judgment table.

FIG. 10 shows an example data structure of an exhibition database.

FIG. 11 shows an example data structure of an exhibition booth database.

FIG. 12 shows an example data structure of a learning content database.

FIG. 13 shows an example data structure of a visitor database.

FIG. 14 shows an example data structure of a booth visit record database.

FIG. 15 shows an example data structure of a booth visit schedule table.

FIG. 16 shows an example data structure of a booth visiting sequence table.

FIG. 17 shows an example data structure of a booth-to-booth moving time table.

FIG. 18 shows a flow chart for determining a list of booths to be visited.

FIG. 19 shows a flow chart for the first half of a procedure for creating the booth visit schedule table.

FIG. 20 shows a flow chart for the second half of the procedure for creating the booth visit schedule table.

FIG. 21 shows a flow chart for determining a visiting sequence.

FIG. 22 shows a flow chart for canceling a booth to be visited.

FIG. 23 shows a flow chart for adding a booth to be visited.

FIG. 24 shows a flow chart for adjusting a scheduled stop period.

FIG. 25 shows a flow chart for adjusting an excess of time.

FIG. 26 shows a flow chart for adjusting a remainder of time.

FIG. 27 shows an example of a given visiting schedule.

FIG. 28 shows an example of an updated visiting schedule.

### DESCRIPTION OF THE PREFERRED EMBODIMENTS

An embodiment of the present invention will be described below with reference to the drawings.

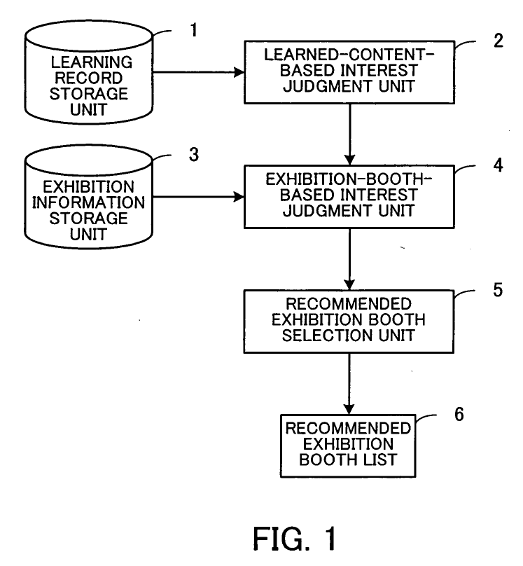

FIG. 1 shows a general configuration of an embodiment of the present invention. The basic elements include a learning record storage unit 1, a learned-content-based interest judgment unit 2, an exhibition information storage unit 3, an exhibition-booth-based interest judgment unit 4, and a recommended exhibition booth selection unit 5.

The learning record storage unit 1 stores user's learning records of technologies, products, services, and the like. The stored learning records are provided by a learning support server which provides a learning environment to the user through a network, like e-learning.

The learned-content-based interest judgment unit 2 calculates a score indicating the degree of user's interest in each field, depending on what the user has learnt in the field, with reference to the learning record storage unit 1. The score indicating the degree of interest rises as the learning grade goes up, such as from the entry level through the intermediate level to the advanced level.

The exhibition information storage unit 3 stores exhibition information describing what is shown at an exhibition booth. The exhibition information is input by the system administrator who has noticed the announcement of an exhibition, for instance.

The exhibition-booth-based interest judgment unit 4 determines a field of content shown at an exhibition booth and totals the scores of learning records in the field, with reference to the exhibition information storage unit 3. The exhibition-booth-based interest judgment unit 4 then calculates a score indicating the degree of user's interest in the exhibition booth.

The recommended exhibition booth selection unit 5 selects exhibition booths having high scores and creates a recommended exhibition booth list 6 for the user. The recommended exhibition booth selection unit 5 judges an appropriate visiting sequence, taking the time required to move between booths into consideration, and can arrange the recommended exhibition booths in accordance with the appropriate sequence. The recommended exhibition booth selection unit 5 can also calculate a scheduled stop period at an exhibition booth in accordance with the degree of user's interest and can plan an appropriate visiting schedule.

The learned-content-based interest judgment unit 2 first calculates a score indicating the degree of user's interest in each field in accordance with what the user has learnt in the field. Then, the exhibition-booth-based interest judgment unit 4 determines a field into which information provided at the exhibition booth is categorized, sums up the scores of learning records in the field, and calculates a score indicating the degree of user's interest in the exhibition booth. The recommended exhibition booth selection unit 5 selects exhibition booths having a high score and creates a recommended exhibition booth list 6 for the user.

Through the processing described above, an exhibition booth that would interest the user is selected in accordance with user's learning records, and the user is informed of the exhibition booth. Consequently, the user can see interesting exhibition booths efficiently.

The degree of user's interest in each field can be judged with a higher accuracy by referring to records of exhibition booths visited in past exhibitions as well as learned contents.

The system of the embodiment of the present invention will be described in detail. The system selects booths a visitor should see at an exhibition, in accordance with the visitor's past stop records, areas of interest, and learning records, optimizes the visiting sequence and stop period, and distributes an education material tailored for the visitor, concerning the state-of-the-art technology information obtained at the exhibition.

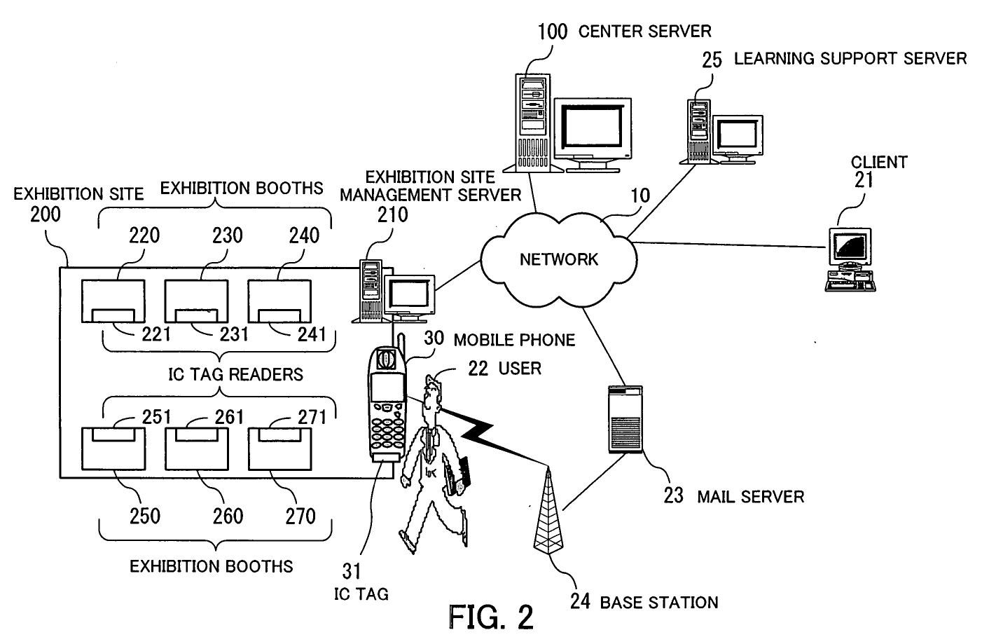

FIG. 2 shows a system configuration of the embodiment. A center server 100, a client 21, a mail server 23, a learning support server 25, and an exhibition site management server 210 are connected via a network 10.

The center server 100 checks learning records of an individual user 22, plans an optimum booth visiting schedule for the user 22 at an exhibition, and informs the user 22 of the schedule. The center server 100 also collects the information of an exhibition booth seen by the user 22, updates the optimum booth visiting schedule whenever necessary, and presents it to the user 22.

The client 21 is a computer used by the user 22. The mail server 23 is a server computer used to provide an electronic mail service through a mobile phone network. The mail server 23 sends electronic mail to a mobile phone 30 possessed by the user 22 through a base station 24 of the mobile phone network. The learning support server 25 provides the user 22 with the information of available learning materials, books, and training courses of a variety of areas that the user 22 can buy or apply for on line.

The mobile phone 30 has a capability of sending and receiving electronic mail, in addition to the call function. The mobile phone 30 contains an IC tag 31, which stores information for uniquely identifying the user 22 possessing the mobile phone 30.

The exhibition site management server 210 is placed in an exhibition site 200. The exhibition site management server 210 is connected to IC tag readers 221, 231, 241, 251, 261, and 271 placed in exhibition booths 220, 230, 240, 250, 260, and 270 in the exhibition site 200.

When the mobile phone 30 containing the IC tag 31 enters a certain area, the IC tag reader 221, 231, 241, 251, 261, or 271 reads the identification information in the IC tag 31 and sends the information to the exhibition site management server 210. When the information received from the IC tag 31 is lost, the IC tag reader 221, 231, 241, 251, 261, or 271 detects that the mobile phone 30 has exited the certain area, and informs the exhibition site management server 210 that the mobile phone 30 has left the certain area.

With reference to FIG. 2, a flow of service to the user in the present embodiment will be described.

When the user 22 applies for admission through the client 21 to the center server 100, the user 22 inputs information by which the level of knowledge of an exhibition booth is judged, such as age, sex, type of occupation, business carrier, certification, skill, learning records, seminar attendance records, exhibition booth visit records, and read books. If the user 22 has received learning support from the learning support server 25, the center server 100 can obtain information of the knowledge level from the learning support server 25. After the application procedure is completed, the user is given a log-in ID and a password on a special page.

The user 22 first logs in on a membership-only page, in order to obtain information required for work. The user 22 accesses the center server 100 from the client 21 and enters the ID and password. Exhibitions due to be held in coming three months are listed on the screen of the client 21, for instance.

When the user 22 selects one exhibition and enters a possible visit period, the center server 100 checks the knowledge level of the user 22, lists exhibition booths that are presumed to be relevant in accordance with the user's membership information of occupation and areas of interest, and displays the list (recommended exhibition booth list) based on the level of importance specified in advance. The user 22 can delete an unnecessary exhibition booth from the list and can add an exhibition booth selected outside the displayed list.

The center server 100 then checks the business carrier, certification, and learning records of the user, judges whether preliminary learning is necessary for a selected exhibition booth, and selects an appropriate learning material if necessary. The information of the material is displayed on the client 21. If the user 22 buys and learns the material, the learning record is added to the learning support server 25. The learning record of the material is supplied from the learning support server 25 to the center server 100.

Based on the results obtained above and the information of the positions of the exhibition booths at the exhibition site, the center server 100 makes a final list of exhibition booths to be visited and determines a sequence of seeing the booths and a stop period at each exhibition booth. The client 21 displays these results.

On the day of the exhibition, the user 22 goes to the exhibition site 200, carrying the mobile phone 30 containing the IC tag 31. When the user 22 carrying the mobile phone 30 reaches an actual exhibition booth at the exhibition site 200, the IC tag reader placed in the exhibition booth sends the logs of the ID of the exhibition booth, reaching time, and leaving time to the center.

Each time there occurs a difference from a prescribed visiting schedule (visiting sequence, stop period, etc.), the center server 100 rearranges the sequence of visiting the recommended exhibition booths and changes the scheduled stop period at each exhibition booth. The center server 100 sends the rearranged schedule to the mobile phone 30 by electronic mail.

After the visit to the exhibition ends, the center server 100 checks learning records related to themes concerning all of the visited exhibition booths and informs the user 22 of any new item that should be learnt by sending the content of the item to the client 21. When the user 22 learns the new item, the user's learning records are updated.

The exhibition booth visiting schedule can be optimized as described above. In addition, prior knowledge of an exhibition booth due to be visited can be acquired efficiently.

The knowledge obtained at an exhibition booth can be improved easily. For instance, the latest trends of the skill and knowledge acquired from in-service training, e-learning or a book can be efficiently obtained and can be effectively linked to further learning.

Functions needed to implement the present embodiment will now be described in detail.

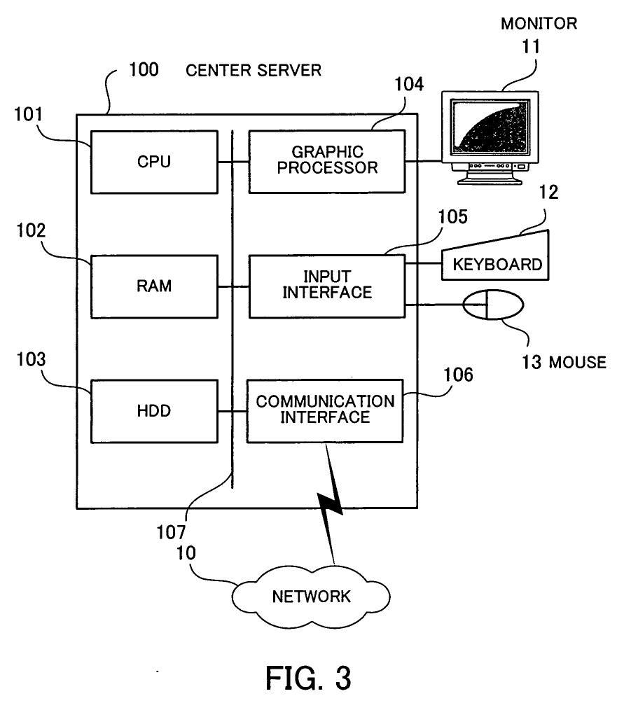

FIG. 3 shows the hardware configuration of the center server 100 of the present embodiment. The entire center server 100 is controlled by a central processing unit (CPU) 101. The CPU 101 is connected to a random access memory (RAM) 102, a hard disk drive (HDD) 103, a graphic processor 104, an input interface 105, and a communication interface 106, through a bus 107.

The RAM 102 temporarily stores at least a part of the operating system (OS) and an application program to be executed by the CPU 101. The RAM 102 also stores a variety of data needed for processing by the CPU 101. The HDD 103 stores the OS and the application program.

The graphic processor 104 is connected to a monitor 11. The graphic processor 104 displays a picture on the screen of the monitor 11 as instructed by the CPU 101. The input interface 105 is connected to a keyboard 12 and a mouse 13. The input interface 105 sends a signal supplied from the keyboard 12 or the mouse 13, via the bus 107 to the CPU 101.

The communication interface 106 is connected to the network 10. The communication interface 106 exchanges data with another computer through the network 10.

With the above-described hardware configuration, processing functions of the present embodiment can be implemented. The client 21 and the exhibition site management server 210 can be implemented by a hardware configuration similar to the hardware configuration of the center server 100 shown in FIG. 3.

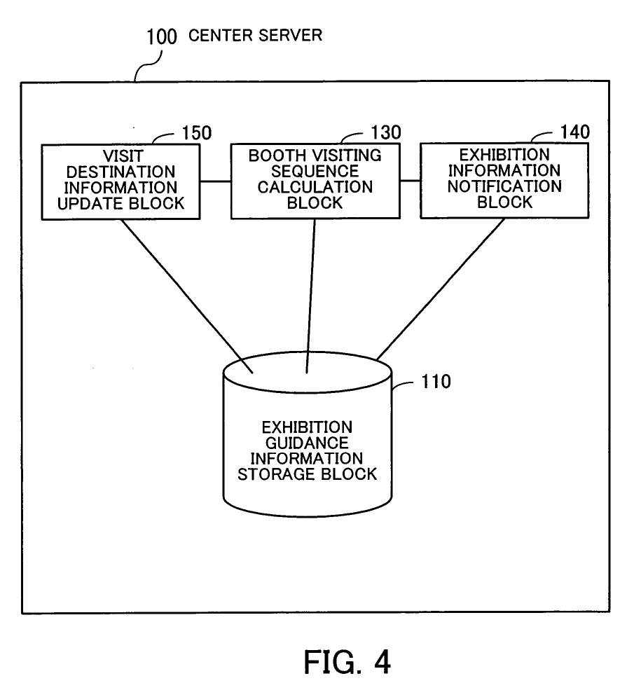

FIG. 4 is a block diagram showing functions of the center server. The center server 100 includes an exhibition guidance information storage block 110, a booth visiting sequence calculation block 130, an exhibition information notification block 140, and a visit destination information update block 150.

The exhibition guidance information storage block 110 stores information of an exhibition to be held, individual learning records, and other information.

The booth visiting sequence calculation block 130 judges the level of knowledge by user's learning records stored in the exhibition guidance information storage block 110 and determines a booth visiting sequence in accordance with the level of the user's knowledge. The booth visiting sequence calculation block 130 contains the basic functions shown in FIG. 1.

The exhibition information notification block 140 informs the user of the booth visiting sequence determined by the booth visiting sequence calculation block 130. Before the user visits the exhibition, the exhibition information notification block 140 sends an announcement of the exhibition and an optimum booth visiting sequence to the client 21 of the user 22 by electronic mail or the like. While the user 22 is in the exhibition site 200, the exhibition information notification block 140 sends the latest booth visiting sequence to the mobile phone of the user 22 by electronic mail.

The visit destination information update block 150 obtains information of exhibition booths the user 22 stopped at from the exhibition site management server 210 and stores the information in the exhibition guidance information storage block 110.

The information stored in the exhibition guidance information storage block 110 will be described in detail.

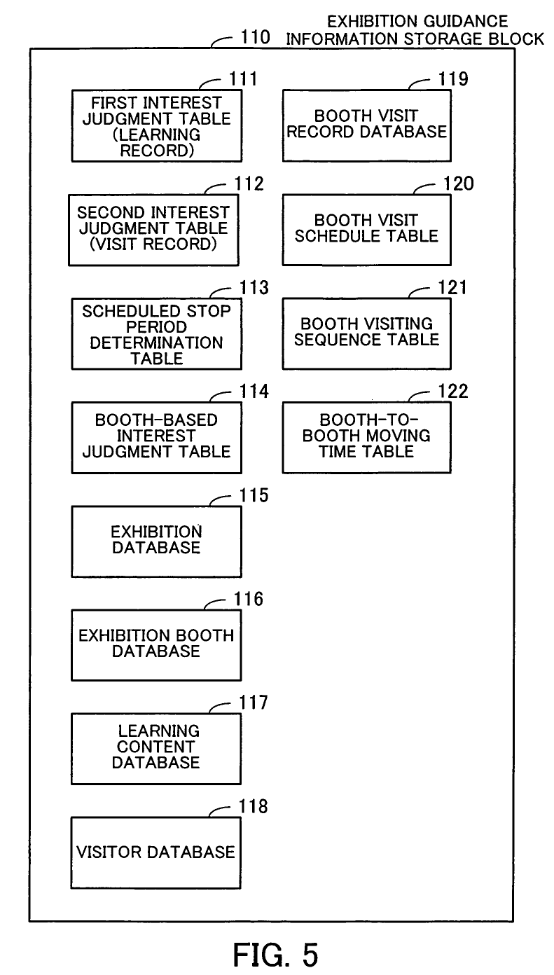

FIG. 5 shows the information stored in the exhibition guidance information storage block 110. As shown in the figure, the exhibition guidance information storage block 110 contains a first interest judgment table 111, a second interest judgment table 112, a scheduled stop period determination table 113, a booth-based interest judgment table 114, an exhibition database 115, an exhibition booth database 116, a learning content database 117, a visitor database 118, a booth visit record database 119, a booth visit schedule table 120, a booth visiting sequence table 121, and a booth-to-booth moving time table 122.

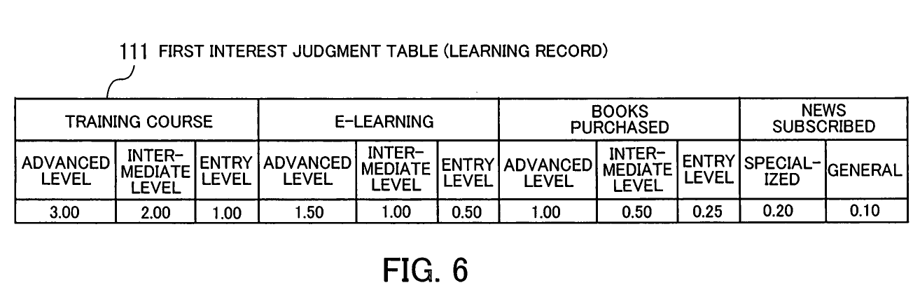

The first interest judgment table 111 defines criteria for judgment of interest based on the learning records of the user 22. FIG. 6 shows an example data structure of the first interest judgment table 111. The table contains scores of learning with which the degree of user's interest is judged in accordance with user's learning records. As shown in the figure, the first interest judgment table 111 has columns of training course, e-learning, books purchased, and news subscribed.

The column of training course is subdivided into columns of advanced level, intermediate level, and entry level. If the user attends a class, the corresponding score indicating the degree of user's interest in the field is given. A greater score is assigned to a class of a higher grade.

The column of e-learning is subdivided into columns of advanced level, intermediate level, and entry level. If the user learns by e-learning, the corresponding score indicating the degree of user's interest in the field is given. A greater score is assigned to a course of a higher grade.

The column of books purchased is subdivided into columns of advanced level, intermediate level, and entry level. If the user buys a book, the corresponding score indicating the degree of user's interest in the field is given. A greater score is assigned to a book of a higher grade.

The column of news subscribed is subdivided into columns of specialized and general. If the user subscribes to specialized news (on-line news distributed in the Internet, for instance) or general news, the corresponding score indicating the degree of user's interest in the field is given. A greater numeric value is assigned to specialized news.

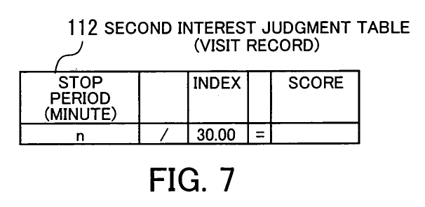

The second interest judgment table 112 defines criteria for judgment of interest based on exhibition booths visited by the user 22. FIG. 7 shows an example data structure of the second interest judgment table 112. An equation for calculating the degree of user's interest depending on the visited exhibition booths is defined in the table. The second interest judgment table 112 has columns of stop period (n), index, and score.

A period of time the user continues to be in an exhibition booth is specified in the column of stop period. A predetermined numeric value is specified in the column of index. The value of stop period divided by the index is specified in the column of score, as a score indicating the degree of user's interest in the corresponding field.

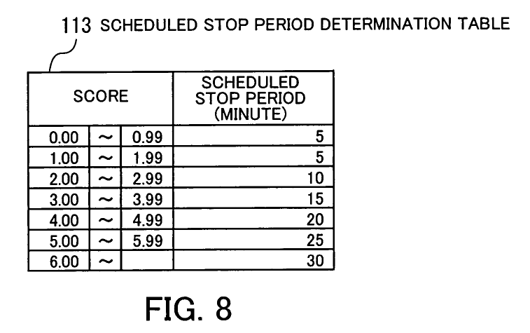

The scheduled stop period determination table 113 stores criteria for calculation of a scheduled stop period at an exhibition booth in accordance with the degree of user's interest. FIG. 8 shows an example data structure of the scheduled stop period determination table 113. The table shows a relationship between a recommended period of time to remain in an exhibition booth and the degree of user's interest in the corresponding field. The scheduled stop period determination table 113 has columns of score and scheduled stop period.

The column of score is divided into different ranges of scores indicating the degree of user's interest in the corresponding field. A recommended stop period corresponding to each score range is specified in minutes, in the column of the scheduled stop period.

A recommended stop period can be determined depending on the degree of interest, with reference to the scheduled stop period determination table 113. For instance, a stop period of 10 minutes is recommended for an exhibition booth in the field having a score indicating the degree of interest of 2.5.

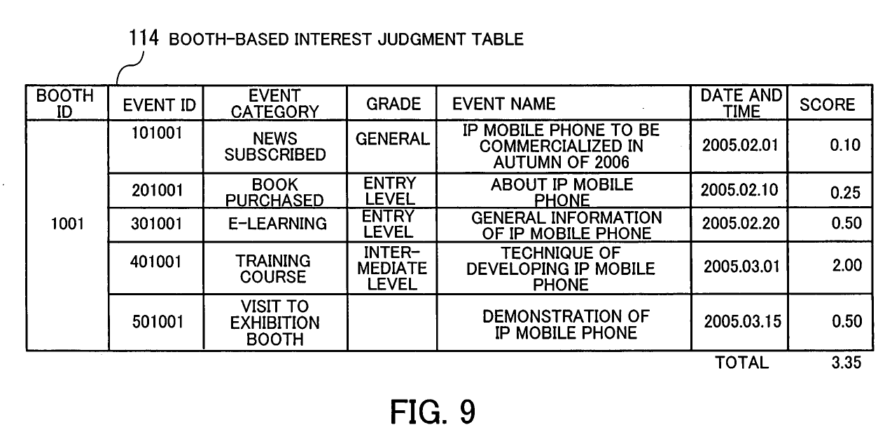

The booth-based interest judgment table 114 stores the result of judgment of the degree of user's interest in each exhibition booth. FIG. 9 shows an example data structure of the booth-based interest judgment table 114. The table shows the degree of user's interest in each exhibition booth and the source information used for calculation. The booth-based interest judgment table 114 has columns of booth ID, event ID, event category, grade, event name, date and time, and score.

The identification number of an exhibition booth is specified in the booth ID column. An identification number indicating user's learning event in the field related to the exhibition booth is specified in the event ID column. The category of the event, such as learning of a material or a visit to an exhibition booth, is specified in the event category column. The grade of the learning event is specified in the grade column.

The name of the event is specified in the event name column. If the event is of learning, the learned material is specified in the column. If an exhibition booth is visited, the theme of the booth is specified in the column. The date and time of the event are specified in the date and time column. The numeric value indicating the degree of user's interest calculated for the event is specified in the score column. The total score is specified at the bottom of the score column.

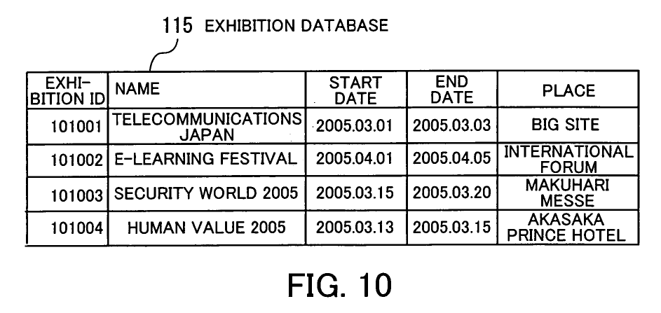

The exhibition database 115 stores information of an exhibition. FIG. 10 shows an example data structure of the exhibition database 115. The database stores the opening and closing schedule, the place, and the like of an exhibition. The exhibition database 115 has columns of exhibition ID, name, start date, end date, and place.

The identification number of an exhibition is specified in the exhibition ID column. The name of the exhibition is specified in the name column. The opening date of the exhibition is specified in the start date column. The closing date of the exhibition is specified in the end date column. The place of the exhibition site is specified in the place column.

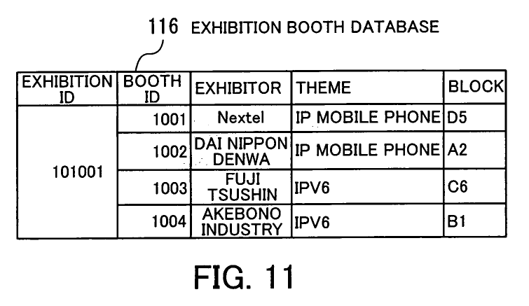

The exhibition booth database 116 stores information of exhibition booths in an exhibition site. FIG. 11 shows an example data structure of the exhibition booth database 116. The database stores the information of exhibitors, places of exhibition booths, and the like. The exhibition booth database 116 has columns of exhibition ID, booth ID, exhibitor, theme, and block.

The identification number of the exhibition is specified in the exhibition ID column. The identification number of each exhibition booth is specified in the booth ID column. The company name of the exhibitor of the exhibition booth is specified in the exhibitor column. The theme of the exhibition booth is specified in the theme column. The identification information indicating the position of the exhibition booth in the exhibition site is specified in the block column.

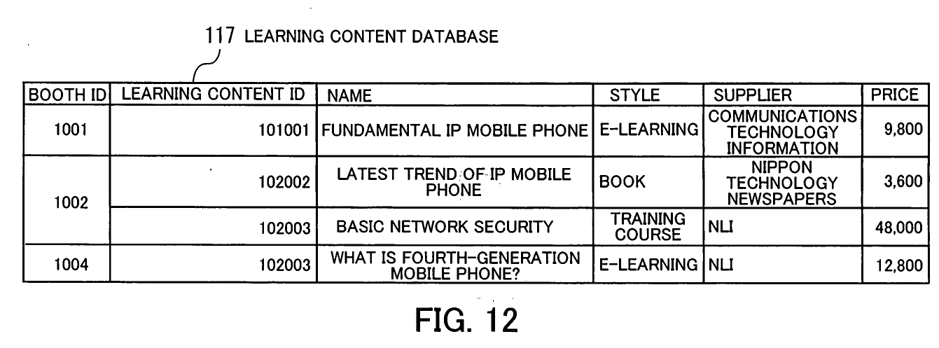

The learning content database 117 stores information of learning materials of e-learning. FIG. 12 shows an example data structure of the learning content database 117. The database stores information of materials that can be learnt by the user through the network. The learning content database 117 has columns of booth ID, learning content ID, name, style, supplier, and price.

The ID of an exhibition booth related to the learning materials is specified in the booth ID column. A number identifying a learning material uniquely is specified in the learning content ID column. The name of the learning material is specified in the name column. The style in which the learning material is provided, such as e-learning, book, training course, etc., is specified in the style column. The name of the company providing the learning material is specified in the supplier column. The selling price of the learning material is specified in the price column.

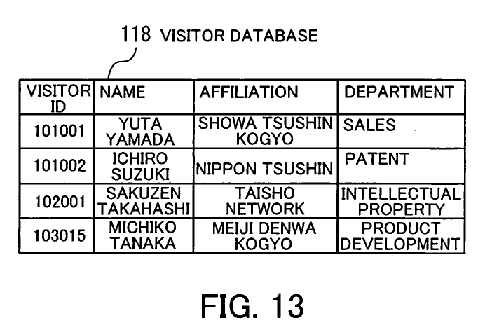

The visitor database 118 stores information of visitors, or the users. FIG. 13 shows an example data structure of the visitor database 118. The database stores information of each user who receives the service of providing an exhibition visiting schedule. The visitor database 118 has columns of visitor ID, name, affiliation, and department.

The identification number of the user (visitor) visiting the exhibition booth is specified in the visitor ID column. The name of the visitor is specified in the name column. The name of the organization to which the visitor belongs is specified in the affiliation column. The name of the department to which the visitor belongs is specified in the department column.

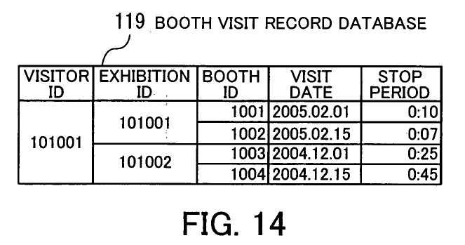

The booth visit record database 119 stores records of exhibition booths visited by the user. FIG. 14 shows an example data structure of the booth visit record database 119. The database stores information of exhibition booths the user has visited. The booth visit record database 119 has columns of visitor ID, exhibition ID, booth ID, visiting date, and stop period.

The identification number of the user is specified in the visitor ID column. The identification number of each exhibition visited by the user is specified in the exhibition ID column. The identification number of each exhibition booth visited by the user is specified in the booth ID column. The user's visit date is specified in the visiting date column. The period in which the user remained in the exhibition booth is specified in the stop period column.

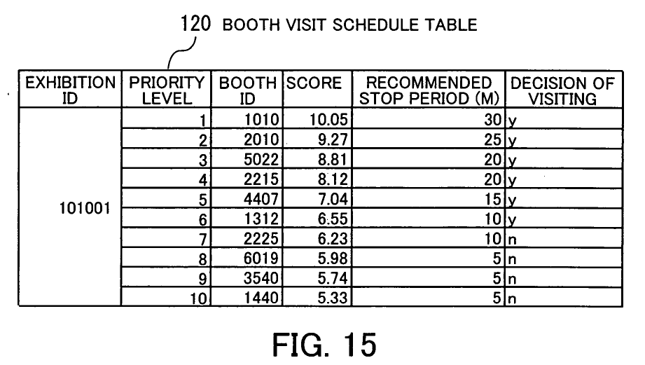

The booth visit schedule table 120 stores information of exhibition booths the user 22 is planning to visit. FIG. 15 shows an example data structure of the booth visit schedule table 120. The table shows an exhibition booth visiting schedule optimized for the user. The booth visit schedule table 120 has columns of exhibition ID, priority level, booth ID, score, recommended stop period, and decision of visiting.

The identification number of the exhibition is specified in the exhibition ID column. The level of priority of visiting an exhibition booth is specified in the priority level column. A smaller value indicates a higher level of priority. The identification number of the exhibition booth is specified in the booth ID column. The calculated score indicating the degree of user's interest in the exhibition booth is specified in the score column. A recommended stop period in the exhibition booth is specified in minutes in the recommended stop period column. A decision made on whether to visit the booth is specified in the column of decision of visiting. If the booth can be visited, “y” is specified. Otherwise, “n” is specified.

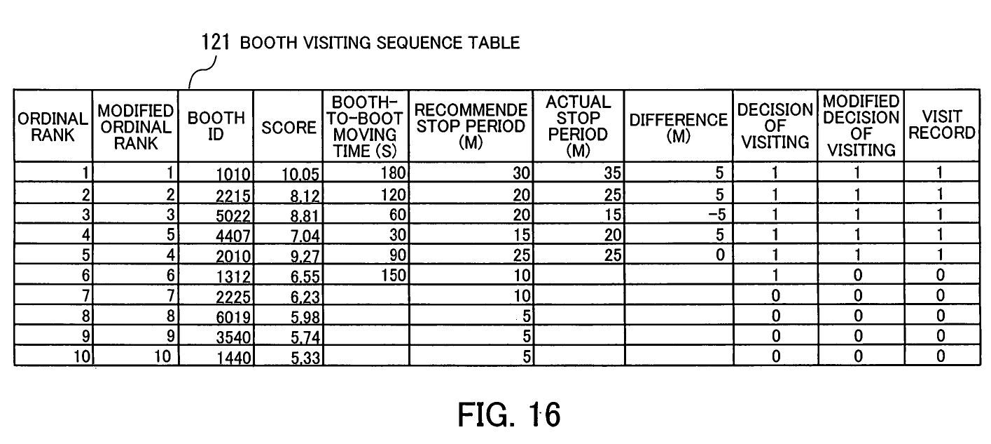

The booth visiting sequence table 121 stores the actual user's visit status of an exhibition booth. FIG. 16 shows an example data structure of the booth visiting sequence table 121. The table stores the user's visit status of an exhibition booth on the day of user's visit to the exhibition. The booth visiting sequence table 121 has columns of ordinal rank, modified ordinal rank, booth ID, score, booth-to-booth moving time, recommended stop period, actual stop period, difference, decision of visiting, modified decision of visiting, and visit record.

An ordinal rank of an exhibition booth in a planned visiting schedule is specified in the ordinal rank column. An ordinal rank of the exhibition booth in a visiting schedule adjusted to the status of the day is specified in the modified ordinal rank column. The identification number of the exhibition booth is specified in the booth ID column. A numeric value indicating user's interest in the exhibition booth is specified in the score column. A moving time to the next booth in the visiting sequence is specified in the booth-to-booth moving time column in seconds. A recommended stop period in the prescribed schedule is specified in minutes in the recommended stop period column.

An actual stop period is specified in minutes in the actual stop period column. The difference between the recommended stop period and the actual stop period, actual stop period minus recommended stop period, is specified in minutes in the difference column. The decision made on whether the booth can be visited at the time of scheduling is specified in the decision of visiting column. If the booth can be visited, “1” is specified. Otherwise, “0” is specified. The decision made on whether the booth can be visited after rescheduling is specified in the modified decision of visiting column. Whether the booth was visited is specified in the visit record column. If the booth was visited, “1” is specified. Otherwise, “0” is specified.

In the example shown in FIG. 16, the exhibition booth having a booth ID “1312” could have been visited, but the exhibition booth could not be visited because the stop periods in other booths exceeded the recommended stop periods.

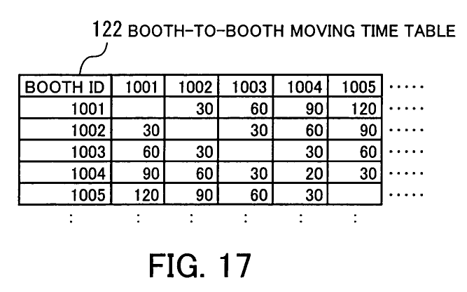

The booth-to-booth moving time table 122 stores a period of time needed to move between exhibition booths. FIG. 17 shows an example data structure of the booth-to-booth moving time table 122. The table shows a time required to move between exhibition booths. The booth-to-booth moving time table 122 shows a booth-to-booth moving time in seconds for each combination of the booth IDs identifying exhibition booths.

In the center server 100 holding all those data, the booth visiting sequence calculation block 130 presents optimum exhibition booths to be visited and calculates an optimum visiting sequence in accordance with the degree and areas of user's interest. The processing executed by the booth visiting sequence calculation block 130 will be described below in detail.

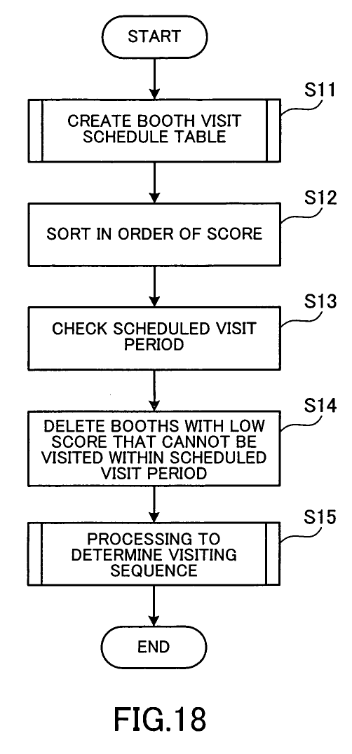

FIG. 18 shows a flow chart for determining a list of booths to be visited. Individual steps will be described in order of step numbers.

Step S11: The booth visiting sequence calculation block 130 executes processing to create a booth visit schedule table 120. The booth visit schedule table 120 contains the degree of user's interest in each exhibition booth (score), a scheduled stop period, and other information. This processing will be described later in detail.

Step S12: The booth visiting sequence calculation block 130 sorts the exhibition booths included in the booth visit schedule table 120 in descending order of score indicating the degree of user's interest.

Step S13: The booth visiting sequence calculation block 130 checks the scheduled visit period in the exhibition site with reference to the booth visit schedule table 120.

Step S14: The booth visiting sequence calculation block 130 deletes booths of low scores that cannot be visited within the scheduled visit period.

Step S15: The booth visiting sequence calculation block 130 executes processing to determine a visiting sequence. This processing will be described later in detail.

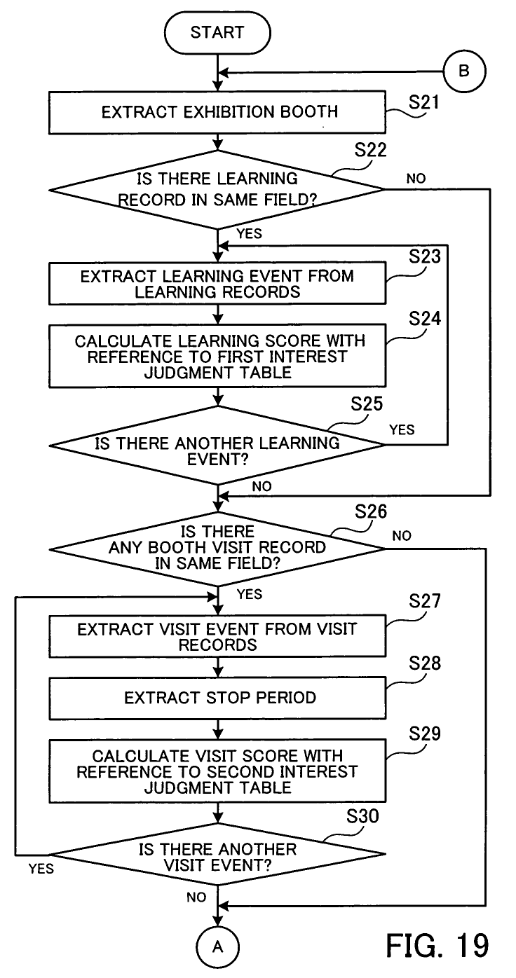

FIG. 19 shows a flow chart for the first half of the procedure for creating the booth visit schedule table. Individual steps will be described in order of step numbers.

Step S21: The booth visiting sequence calculation block 130 extracts one new exhibition booth from the exhibition booth database 116.

Step S22: The booth visiting sequence calculation block 130 obtains the learning records of the user 22 from the learning support server 25 and judges whether the user has a learning record in the field of the theme of the exhibition booth. If yes, the processing goes to step S23. If no, the processing goes to step S26.

If the theme of the exhibition booth and the name of a learning material include a common technical term, they are judged to be in the same field. The fields to which learning materials and exhibition booths belong may be specified in the center server 100 beforehand, and whether a theme and a learning record fall in an identical field may be checked.

Step S23: The booth visiting sequence calculation block 130 extracts one new learning event from the learning records in the same field as the exhibition booth.

Step S24: The booth visiting sequence calculation block 130 calculates a learning score of the learning event extracted in step S23, with reference to the first interest judgment table 111.

Step S25: The booth visiting sequence calculation block 130 checks whether there remains a learning event which has not yet been extracted from the learning records in the same field as the exhibition booth. If yes, the processing goes back to step S23. If no, the processing goes to step S26.

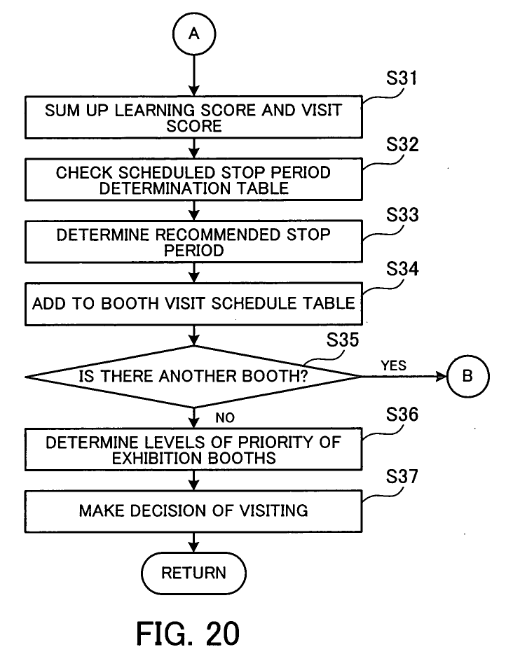

Step S26: The booth visiting sequence calculation block 130 checks whether another exhibition booth in the same field as the extracted booth has been visited, with reference to the booth visit record database 119. The field of the exhibition booth can be confirmed with reference to the theme column of the exhibition booth database 116 provided for each exhibition. If any booth has been visited, the processing goes to step S27. If no booth has been visited, the processing goes to step S31 (see FIG. 20).

Step S27: The booth visiting sequence calculation block 130 extracts a visit event (record) in the same field as the extracted exhibition booth, from the booth visit record database 119.

Step S28: The booth visiting sequence calculation block 130 extracts stop period information from the extracted visit event.

Step S29: The booth visiting sequence calculation block 130 calculates a visit score of the visit event extracted in step S27, with reference to the second interest judgment table 112.

Step S30: The booth visiting sequence calculation block 130 checks whether there is a non-extracted visit event among visit events in the same field as the extracted exhibition booth. If yes, the processing goes back to step S27. If no, the processing goes to step S31 (see FIG. 20).

FIG. 20 shows a flow chart for the second half of the procedure for creating the booth visit schedule table. Individual steps will be described in order of step numbers.

Step S31: The booth visiting sequence calculation block 130 sums up the learning score and the visit score. Then, the booth visiting sequence calculation block 130 creates a booth-based interest judgment table 114 for the exhibition booth for which the scores have been added and stores the table in the exhibition guidance information storage block 110.

Step S32: The booth visiting sequence calculation block 130 checks the scheduled stop period determination table 113.

Step S33: The booth visiting sequence calculation block 130 determines a scheduled stop period depending on the total score, thereby determining recommended stop periods in such a manner that a longer stop period is assigned to a booth having a higher score (higher degree of interest).

Step S34: The booth visiting sequence calculation block 130 adds the information of the exhibition booth extracted in step S21 to the booth visit schedule table 120.

Step S35: The booth visiting sequence calculation block 130 checks whether there is a non-extracted exhibition booth. If yes, the processing goes back to step S21 (FIG. 19). If no, the processing goes to step S36.

Step S36: The booth visiting sequence calculation block 130 determines the levels of priority of the exhibition booths so that a higher level of priority (a smaller value) is assigned to an exhibition booth having a higher score in the booth visit schedule table 120.

Step S37: The booth visiting sequence calculation block 130 selects exhibition booths that can be visited within the period to remain in the exhibition site 200 specified in advance by the user 22 in descending order of priority, and specifies “y” in the column of decision of visiting. The booth visiting sequence calculation block 130 also specifies “n” for the exhibition booths that cannot be visited within the scheduled period. In this step, the booth visiting sequence calculation block 130 does not consider the booth-to-booth moving time and makes a decision just on the sum of the recommended stop periods at the exhibition booths. Then, the processing ends.

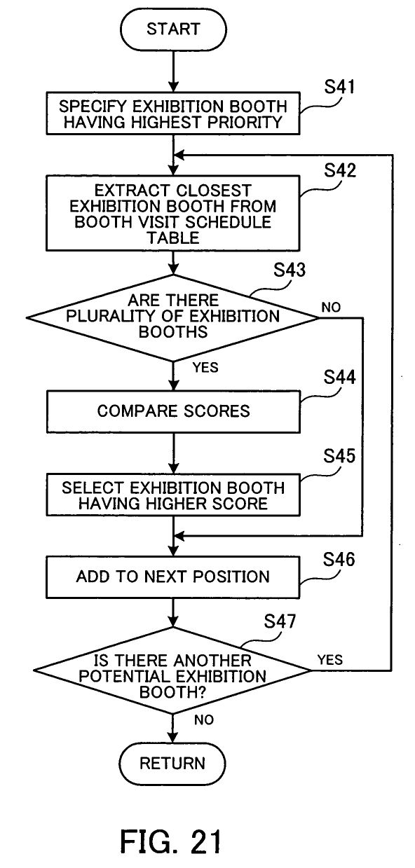

FIG. 21 shows a flow chart for determining a visiting sequence. Individual steps will be described in order of step numbers.

Step S41: The booth visiting sequence calculation block 130 adds an exhibition booth having the highest score in the booth visit schedule table 120 to a booth visiting sequence table 121 and places it in the top position.

Step S42: The booth visiting sequence calculation block 130 extracts an exhibition booth closest (having a shortest distance) to the exhibition booth added to the booth visiting sequence table 121 in the immediately preceding step, from the booth visit schedule table 120.

Step S43: The booth visiting sequence calculation block 130 checks whether a plurality of exhibition booths have been extracted. If yes, the processing goes to step S44. If no, the processing goes to step S46.

Step S44: The booth visiting sequence calculation block 130 compares the scores of the extracted exhibition booths.

Step S45: The booth visiting sequence calculation block 130 selects an exhibition booth having a higher score as the booth to be added.

Step S46: The booth visiting sequence calculation block 130 adds the extracted exhibition booth or the exhibition booth selected in step S45 when a plurality of exhibition booths have been extracted to the next position in the booth visiting sequence table 121.

Step S47: The booth visiting sequence calculation block 130 checks whether there remains a non-extracted potential exhibition booth in the booth visit schedule table 120. If yes, the processing goes back to step S42. If no, the processing ends.

Now, the booth visiting sequence table 121 is created. The exhibition information notification block 140 sends the contents of the booth visiting sequence table 121 to the client 21.

When the user 22 reaches the exhibition site 200, the exhibition booths visited by the user 22 and the corresponding stop periods are monitored by means of the IC tag 31 contained in the mobile phone 30. The monitored results are sent from the exhibition site management server 210 to the center server 100. If any difference is found between the activity of the user 22 and the schedule, the center server 100 changes the booth visiting sequence.

If the user 22 skips an exhibition booth to be visited, the center server 100 cancels the booth to be visited.

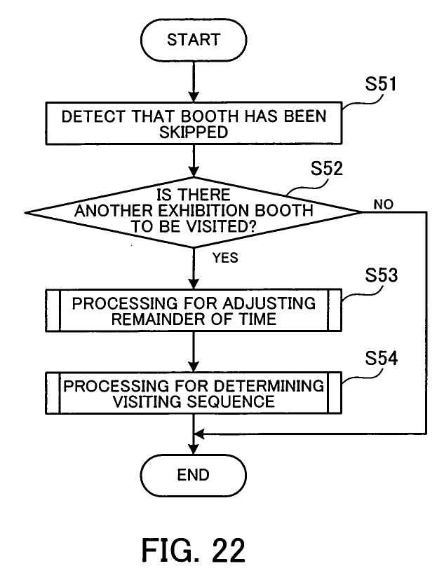

FIG. 22 shows a flow chart for canceling a booth to be visited. Individual steps will be described in order of step numbers.

Step S51: The booth visiting sequence calculation block 130 detects that a booth to be visited has been skipped when the user 22 goes to an exhibition booth without stopping at the immediately preceding booth in the booth visiting sequence table 121.

Step S52: The booth visiting sequence calculation block 130 checks whether there remains an exhibition booth to be visited (expect the exhibition booth to be visited that has been skipped). If yes, the processing goes to step S53. If no, the processing ends.

Step S53: The booth visiting sequence calculation block 130 performs the processing for adjusting a remainder of time. This processing will be described later in detail.

Step S54: The booth visiting sequence calculation block 130 carries out the procedure for determining a visiting sequence (FIG. 21), then the processing ends.

If the user 22 skips an exhibition booth to be visited, the visiting sequence is rearranged in this way.

If the user 22 stops at an unscheduled exhibition booth, processing to add an exhibition booth is performed.

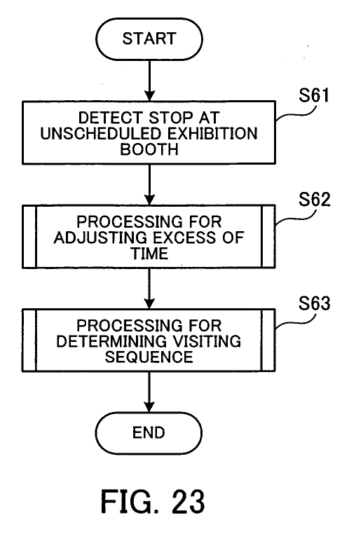

FIG. 23 shows a flow chart for adding a booth to be visited. Individual steps will be described in order of step numbers.

Step S61: The booth visiting sequence calculation block 130 detects that the user 22 has stopped at an unscheduled exhibition booth.

Step S62: The booth visiting sequence calculation block 130 executes the processing for adjusting an excess of time. The processing will be described later in detail.

Step S63: The booth visiting sequence calculation block 130 carries out the procedure for determining a visiting sequence (FIG. 21), then the processing ends.

If the user 22 stops at an unscheduled booth, the visiting sequence is rearranged in this way.

The user 22 may not remain in an exhibition booth as scheduled. When the user 22 leaves an exhibition booth, the booth visiting sequence calculation block 130 adjusts the time in accordance with the stop period in the exhibition booth.

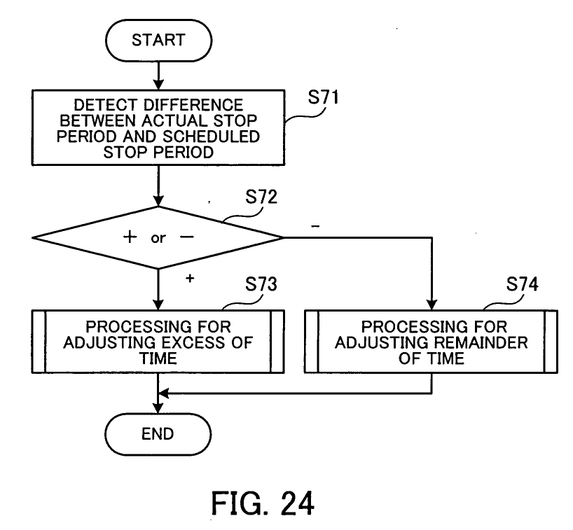

FIG. 24 shows a flow chart for adjusting the scheduled stop period. Individual steps will be described in order of step numbers.

Step S71: The booth visiting sequence calculation block 130 detects whether the actual stop period in a booth differs from the scheduled stop period.

Step S72: The booth visiting sequence calculation block 130 subtracts the recommended stop period from the actual stop period. If the difference is a positive value, the processing goes to step S73. If the difference is a negative value, the processing goes to step S74.

Step S73: The booth visiting sequence calculation block 130 performs the processing for adjusting an excess of time, which will be described later in detail, and the processing ends.

Step S74: The booth visiting sequence calculation block 130 performs the processing for adjusting a remainder of time, which will be described later in detail, and the processing ends.

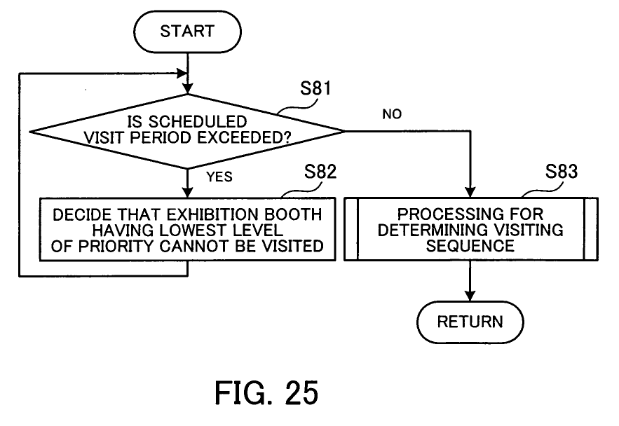

FIG. 25 shows a flow chart for adjusting an excess of time. Individual steps will be described in order of step numbers.

Step S81: The booth visiting sequence calculation block 130 checks whether the total period required to visit all the exhibition booths that are considered to be possible to visit exceeds the scheduled visit period (specified beforehand by the user 22), with reference to the booth visiting sequence table 121. If yes, the processing goes to step S82. If no, the processing goes to step S83.

Step S82: With reference to the booth visit schedule table 120, the booth visiting sequence calculation block 130 decides that the exhibition booth having the lowest level of priority among the unvisited exhibition booths (“0” in the visit record column) in the booth visiting sequence table 121 cannot be visited (specifies “0” in the column of modified decision of visiting). The processing goes back to step S81.

Step S83: The booth visiting sequence calculation block 130 carries out the procedure for determining a visiting sequence (FIG. 21), then the processing ends.

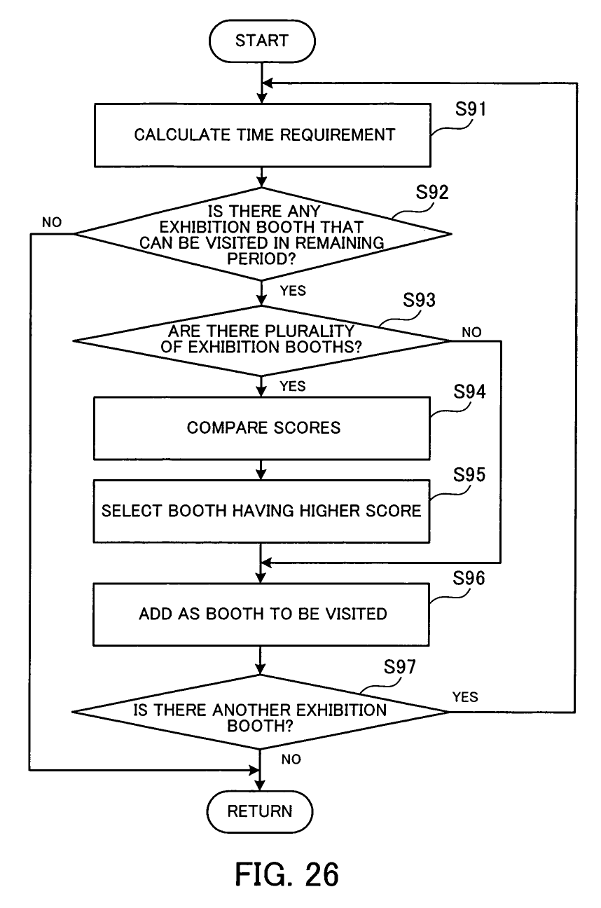

FIG. 26 shows a flow chart for adjusting a remainder of time. Individual steps will be described in order of step numbers.

Step S91: The booth visiting sequence calculation block 130 calculates the total period of time required to visit all the exhibition booths that are considered to be possible to visit. If the period decreases because of a skip of a booth to be visit or the like, the reduced period is calculated.

Step S92: With reference to the booth visiting sequence table 121, the booth visiting sequence calculation block 130 judges whether an exhibition booth can be visited in the remaining period. If yes, the processing goes to step S93. If no, the processing ends.

Step S93: The booth visiting sequence calculation block 130 checks whether a plurality of exhibition booths can be visited in the remaining period. If yes, the processing goes to step S94. If no, the processing goes to step S96.

Step S94: The booth visiting sequence calculation block 130 compares the scores of the exhibition booths that can be visited in the remaining period.

Step S95: The booth visiting sequence calculation block 130 selects an exhibition booth having the highest score.

Step S96: The booth visiting sequence calculation block 130 specifies that the selected exhibition booth is to be visited (assigns “1” as a value of modified decision of visiting).

Step S97: The booth visiting sequence calculation block 130 checks whether another exhibition booth can be visited. If yes, the processing goes to step S91. If no, the processing ends.

Each time the booth visiting schedule is modified, the updated schedule is sent to the mobile phone 30 of the user 22 by electronic mail.

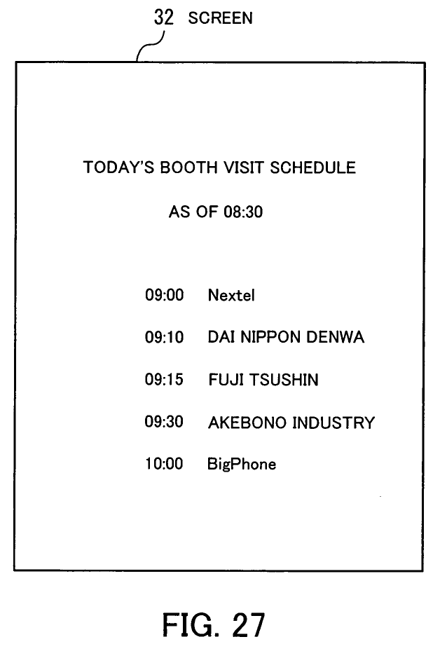

FIG. 27 shows an example of a given visiting schedule. The shown schedule is sent from the center server 100 to the mobile phone 30 in the morning of the day to visit the exhibition site 200. A display screen 32 of the mobile phone 30 displays a booth visiting schedule of the day.

When the user 22 reaches the exhibition site and goes to an exhibition booth, the visiting schedule is updated in accordance with the actual stop period, and the updated information is sent to the mobile phone 30.

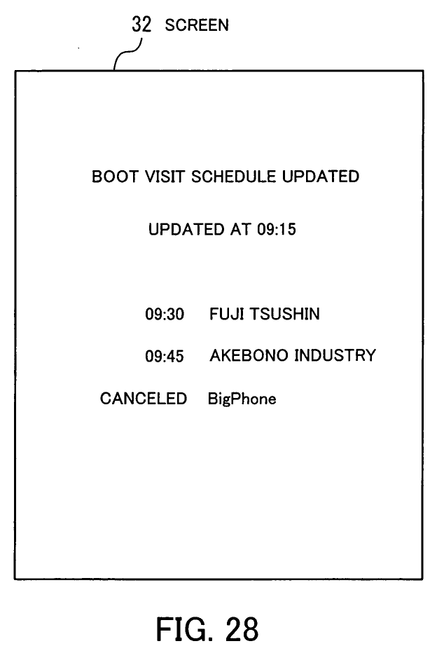

FIG. 28 shows an example of an updated visiting schedule. The screen 32 of the mobile phone 30 displays a list of exhibition booths that have not yet been visited. Any exhibition booth that cannot be visited because of the limit of time is marked as “canceled.”

An appropriate sequence of visiting exhibition booths can be given to the user as described above. If the booths are not visited as scheduled, the visiting schedule modified as appropriate is given to the user.

The system can advise the user to learn an education material related to an exhibition booth prior to the actual visit, if necessary, in liaison with the learning support server 25. After the actual visit to the exhibition booths, the system can extract a new technology, product, or service for the user with reference to the past stop records and learning records and can advise the user to learn an education material related to the new technology, product, or service.

After the visit to the exhibition, the learning records will be used to optimize a next exhibition visiting schedule. As a result, the degree of user's interest in each field can be determined with a higher accuracy.

In the embodiment described above, the IC tag readers 221, 231, 241, 251, 261, and 271 read the IC tag 31 contained in the mobile phone 30 in order to keep track of the booths visited by the user. The booths visited by the user 22 can also monitored by another method. For instance, the user 22 reads a bar code provided in a visited exhibition booth by means of the mobile phone 30 and sends it to the center server 100. Based on the sent bar code information, the center server 100 identifies the exhibition booth visited by the user 22.

The processing functions described above can be implemented by a computer. In that case, a program describing the functions that the center server should have are provided. The processing functions are implemented on the computer when the program is executed by the computer. The program describing the processing can be stored in a computer-readable recording medium. Computer-readable recording media include magnetic recording apparatuses, optical discs, magneto-optical recording media, and semiconductor memory. Magnetic recording apparatuses include a hard disk drive (HDD), a flexible disk (FD), and a magnetic tape. Optical discs include a digital versatile disc (DVD), a digital versatile disc random access memory (DVD-RAM), a compact disc read only memory (CD-ROM), a compact disc recordable (CD-R), and a compact disc rewritable (CD-RW). Magneto-optical recording media include a magneto-optical disk (MO).

The program is distributed in the form of a transportable recording medium storing the program, such as a DVD or a CD-ROM. The program can also be stored in a storage apparatus of a sever computer and can be transferred from the server computer to another computer via a network.

A computer that executes the program stores the program recorded in a transportable recording medium or the program transferred from the server computer in its internal memory. The computer reads the program from the internal memory and executes the processing in accordance with the program. The computer can also read the program directly from the transportable recording medium and can execute the processing in accordance with the program. The computer can also executes the processing in accordance with the program each time the program is transferred from the server computer.

The present invention is not limited to the embodiment described above, and a variety of modifications can be added within the scope of the present invention.

The present invention determines the degree of user's interest in each field in accordance with the learning records of the user, extracts exhibition booths that would interest the user, and generates a list of recommended exhibition booths to be visited. With reference to the list of recommended exhibition booths, the user can see exhibition booths related to the area of user's interest efficiently.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium having stored a recommended exhibition booth selection program for selecting a recommended exhibition booth that would interest the user as a visit destination at an exhibition, the program making a computer function as:
a learned-content-based interest judgment means for calculating a score indicating the degree of user's interest in each field, depending on what the user has learnt in the field, with reference to a learning record storage means storing learning records indicating what the user has learnt;
an exhibition-booth-based interest judgment means for determining, with reference to an exhibition information storage means storing exhibition information describing a content shown at each booth of an exhibition to be held, a field of content provided at the exhibition booth, summing up scores concerning learning records in the field, and calculating a score indicating the degree of user's interest in the exhibition booth; and
a recommended exhibition booth selection means for creating a list of exhibition booths recommended to the user by selecting an exhibition booth having a high score with priority as a visit destination.

2. The computer-readable recording medium having stored a recommended exhibition booth selection program according to claim 1, the program making the computer function further as:
a visited-exhibition-record-based interest judgment means for calculating a score indicating the degree of user's interest in each field, depending on exhibition booths the user has visited in the field, with reference to a visited exhibition record storage means storing visited exhibition records concerning exhibition booths the user visited in a past exhibition,
the exhibition-booth-based interest judgment means summing up the scores concerning learning records and scores concerning visit records in the field of content shown at the exhibition booth and calculating the score indicating the degree of user's interest in the exhibition booth.

3. The computer-readable recording medium having stored a recommended exhibition booth selection program according to claim 1, the program making the computer function further as:
a visit destination information update means for acquiring information of an exhibition booth visited by the user at the site of the exhibition under way and updating visit destination information indicating exhibition booths visited by the user at the site of the exhibition under way,
the recommended exhibition booth selection means updating the list of recommended exhibition booths each time the visit destination information is updated.

4. The computer-readable recording medium having stored a recommended exhibition booth selection program according to claim 1, wherein the recommended exhibition booth selection means calculates an appropriate visiting sequence based on the moving time between selected exhibition booths and rearranges the recommended exhibition booth list in accordance with the visiting sequence.

5. The computer-readable recording medium having stored a recommended exhibition booth selection program according to claim 1, wherein the recommended exhibition booth selection means calculates a stop period at each exhibition booth depending on the degree of user's interest in the selected exhibition booth and determines a schedule of visiting exhibition booths in accordance with the stop period.

6. A recommended exhibition booth selection method for selecting a recommended exhibition booth that would interest the user as a visit destination at an exhibition by a computer, the recommended exhibition booth selection method comprising the steps of:
calculating a score indicating the degree of user's interest in each field, depending on what the user has learnt in the field, with reference to a learning record storage means storing learning records indicating what the user has learnt;
determining, with reference to an exhibition information storage means storing exhibition information describing a content shown at each booth of an exhibition to be held, a field of content provided at the exhibition booth, summing up scores concerning learning records in the field, and calculating a score indicating the degree of user's interest in the exhibition booth; and
creating a list of exhibition booths recommended to the user by selecting an exhibition booth having a high score with priority as a visit destination.

7. A recommended exhibition booth selection apparatus for selecting a recommended exhibition booth that would interest the user at an exhibition, the recommended exhibition booth selection apparatus comprising:
a learned-content-based interest judgment means for calculating a score indicating the degree of user's interest in each field, depending on what the user has learnt in the field, with reference to a learning record storage means storing learning records indicating what the user has learnt;
an exhibition-booth-based interest judgment means for determining, with reference to an exhibition information storage means storing exhibition information describing a content shown at each booth of an exhibition to be held, a field of content provided at the exhibition booth, summing up scores concerning learning records in the field, and calculating a score indicating the degree of user's interest in the exhibition booth; and
a recommended exhibition booth selection means for creating a list of exhibition booths recommended to the user by selecting an exhibition booth having a high score with higher priority as a visit destination.
